(19) United States
(12) Patent Application Publication
(10) Pub. No.: US 2024/0332972 A1
(43) Pub. Date: Oct. 3, 2024

(54) CONTROL OF FORCED OSCILLATIONS

(71) Applicant: THE UNIVERSITY OF BIRMINGHAM, Birmingham (GB)

(72) Inventors: Xiao-Ping ZHANG, Birmingham (GB); Ying XUE, Birmingham (GB); Xianxian ZHAO, Birmingham (GB)

(21) Appl. No.: 18/277,865

(22) PCT Filed: Feb. 18, 2022
(86) PCT No.: PCT/EP2022/054158

§ 371 Date: Aug. 18, 2023

(30) Foreign Application Priority Data
Feb. 19, 2021 (GB) 2102374.2

(51) Int. Cl. H02J 3/24; F03D 7/02; H02J 3/38

(52) U.S. Cl. CPC H02J 3/24; F03D 7/0284; H02J 3/38; F05B 2270/101; F05B 2270/20; F05B 2270/327; H02J 2300/28

(57) ABSTRACT

A method of isolating or suppressing forced oscillations in a power grid by utilising a wind turbine system comprising a wind turbine for capturing wind power, a generator driven by the wind turbine, and a power converter configured to control the rotational speed of the generator for controlling a supply of active power to the power grid. The power converter is further configured to supply reactive power to the power grid independently from the supply of active power. The method comprising the steps of: obtaining measurements of a forced oscillation occurring within the power grid; controlling the converter to supply active and reactive corrective oscillating power to the power grid in response to the measured forced oscillation such that the corrective oscillating power suppresses the forced oscillations.

### TECHNICAL FIELD

This invention relates to the control of forced oscillations in power grids. In particular, the invention relates to control of forced oscillations using an isolation and suppression technique.

### BACKGROUND

Frequency oscillations in power grids are a threat to the security and stability of power systems. Based on the cause of the oscillations, they can be categorised into two main categories: free oscillations and forced oscillations. Free oscillations result from the natural interaction between dynamic devices. In contrast, forced oscillations refer to system responses to an external period perturbation.

Forced oscillations in power grids are produced by periodic external disturbances typically at frequencies close or equal to the natural frequencies of the system modes. The external periodic disturbances may include cyclic loads, electrical oscillations caused by malfunctions of power system stabilizers (PSSs) in power plants, mechanical oscillations of synchronous generator turbines, and periodically fluctuating wind power due to wind shear and tower shadow effects, etc. Compared with free/natural oscillations, forced oscillations exhibit much higher magnitude and may have significant consequences, especially under poorly damped operating conditions.

Countermeasures for forced oscillations are typically different from those for natural oscillations. Generally, there are three categories of methods to minimize the adverse impact from forced oscillations, namely, (a) elimination of forced oscillations; (b) damping of forced oscillations; and (c) isolation and suppression of forced oscillations. The first category of methods aims to completely eliminate forced oscillations by removing the external fluctuating forces. However, this removal is difficult and sometimes even impossible to realise due to two reasons. The first is that it requires accurate and timely location of external fluctuating forces, which is difficult to achieve. Many online localisation methods such as graph-theoretic method (T. R. Nudell, S. Nabavi, and A. Chakrabority, “A real-time attack localization algorithm for large power system networks using graph-theoretic techniques,” IEEE Trans. Smart Grid, vol. 6, no. 5, pp. 2551-2559, 2015) as incorporated by reference herein, forecasting residual spectrum analysis method (M. Ghorbaniparvar, N. Zhou, X. Li, D. Trudnowski, and R. Xie, “A forecasting-residual spectrum analysis method for distinguishing forced and natural oscillations,” IEEE Trans. Smart Grid, pp. 1-1, 2017) as incorporated by reference herein, and energy based methods (L. Chen, Y. Min, and W. Hu, “An energy-based method for location of power system oscillation source,” IEEE Trans. Power Syst., vol. 28, no. 2, pp. 828-836, 2013), as incorporated by reference herein, have been proposed. The former two methods rely on accurate system models. For the latter method, the relationship between relative oscillation energy and the actual oscillating active power is unclear.

The second reason is that the external perturbation sources can be small or within some critical power plants or loads, making it neither practical nor economic to remove.

F. M. Hughes, O. Anaya-Lara, G. Ramtharan, N. Jenkins, and G. Strbac, “Influence of tower shadow and wind turbulence on the performance of power system stabilizers for DFIG-based wind farms,” IEEE Trans. Energy Convers., vol. 23, no. 2, pp. 519-528, 2008, and T. Surinkaew, M. R. Shah, S. M. Muyeen, M. Nadarajah, K. Emami and I. Ngamroo, “Novel Control Design for Simultaneous Damping of Inter-area and Forced Oscillation,” IEEE Transactions on Power Systems, doi: 10.1109/TPWRS.2020.3009422., as incorporated by reference herein, propose increasing power system damping to suppress forced oscillations, by using PSSs, flexible AC transmission system (FACTS)-based stabilizers and other power converter-controlled devices. However, i) this method cannot completely eliminate forced oscillations; ii) unlike natural oscillations which can be attenuated quickly when the damping of the system is improved, forced oscillations can still occur and be sustained; and iii) power system transfer function needs to be known, which however is difficult to be precisely and timely estimated and not likely to be stationary.

The third category of corrective methods aims to isolate and suppress forced oscillations. Based on such methods, the propagation of forced oscillations from the disturbed generator/area to the rest of the power grid is stopped, and subsequently, the forced oscillations of the disturbed generator/area can be reduced. In S. Feng, X. Wu, P. Jiang, L. Xie, and J. Lei, “Mitigation of power system forced oscillations: an E-STATCOM approach,” IEEE Access, vol. 6, pp. 31599-31608, 2018, as incorporated by reference herein, an E-STATCOM approach was proposed to isolate and suppress forced oscillations by incorporating an energy storage unit into static synchronous compensator (STATCOM). The disadvantages of this scheme are twofold. The first disadvantage is that extra power electronic hardware and energy storage devices are required, and the cost and maintenance requirements of the associated devices must be considered. Second, resonant controllers are adopted that require a prior knowledge of the frequency of the external disturbance. In D. J. Trudnowski and R. Guttromson, “A Strategy for Forced Oscillation Suppression,” IEEE Transactions on Power Systems, vol. 35, no. 6, pp. 4699-4708, November 2020, doi: 10.1109/TPWRS.2020.2994855., as incorporated by reference herein, a feedback-control oppression approached is proposed. However, the oppression performance greatly depends on the prior knowledge of the power system transfer function and frequency of forced oscillation, which are not likely to be timely estimated and stationary. In J. Tan, X. Wang, T. Wang, and Y. Zhang, “Alleviation of oscillations power of wind farm using flywheel energy storage,” in Proc. IEEE Power Energy Soc. Gen. Meeting, July 2014, pp. 1-5, as incorporated by reference herein, the installation of an extra flywheel was proposed to smooth the wind power of a wind farm, WF, due to wind shear and tower shadow effects which would induce forced oscillations in the power system. Instead of installing an extra flywheel, in C. Su, W. Hu, Z. Chen, and Y. Hu, “Mitigation of power system oscillation caused by wind power fluctuation,” IET Renew. Power Gener., vol. 7, no. 6, pp. 639-651, 2013, as incorporated by reference herein, (ii) the DC-link capacitor was utilized in a permanent magnetic synchronous generator (PMSG)-based wind turbine system (WTS) with the same power compensation control as that in (i) to smooth the wind power of a WF. However, the method proposed in (i) requires the installation of extra flywheel energy storage systems, and the method proposed in (ii) has limited suppression capability due to the small energy storage capacity of the DC-link capacitor.

The present invention seeks to provide a different and improved method for addressing forced oscillations in a power system.

### SUMMARY

According to a first aspect of the invention there is provided a method of isolating or suppressing forced oscillations in a power grid by utilising a wind turbine system comprising a wind turbine for capturing wind power, a generator driven by the wind turbine, and a power converter configured to control the rotational speed of the generator for controlling a supply of active power to the power grid, the power converter further configured to supply reactive power to the power grid independently from the supply of active power, the method comprising the steps of: obtaining measurements of a forced oscillation occurring within the power grid; controlling the converter to supply active and reactive corrective oscillating power to the power grid in response to the measured forced oscillation such that the corrective oscillating power suppresses the forced oscillations.

The wind turbine system may be an onshore or offshore wind turbine system, optionally, using a fixed or floating platform on which a wind turbine is mounted. The wind turbine system may be any device that converts kinetic energy from the wind into electrical energy and the wind turbine may be a horizontal or vertical axis wind turbine. The power grid may be a national grid that is connected to generators such as coal or hydroelectric power plants.

Optionally, the corrective oscillating power is provided by controlling the converter to release or absorb active and/or reactive power opposite to the measured forced oscillation.

Optionally, the corrective oscillating active power is provided by the inertial kinetic energy stored in the wind turbine system when below a rated wind speed of the wind turbine and/or by using excess wind energy when above the rated wind speed.

Optionally, the rotational speed of the wind turbine is controlled depending on the wind speed of air flowing through the wind turbine in order for the wind turbine system to maximise wind power capture for supplying the grid and for supplying an active component of the corrective oscillating power.

Optionally, a pitch angle of one or more blades of the wind turbine is adjusted to extract additional energy from wind flowing through the wind turbine whilst the rotational speed of the wind turbine remains at a maximum rated rotational speed and wherein the additional energy is utilised for generating the active component of the corrective oscillating power.

Optionally, the power grid comprises a first area in which the forced oscillations originate and which is electrically connected to a second area, the method comprising obtaining the measurements of the forced oscillation power occurring within the first area and injecting the corrective oscillating power into the power grid into the second area.

The second area may comprise multiple other areas of the power grid.

Optionally, the corrective oscillating power is injected between the first and second area.

Optionally, the oscillating power in the first area is measured at a connection point between the wind turbine system and the first area by using one or more measurement devices including any of a remote measurement unit, phasor measurement unit, synchronised measurement unit, and other real-time measurement unit.

Optionally, measurements of forced and/or natural oscillating power are obtained by applying a low pass filter to the measurements of the total oscillating power, wherein the low ass filter is separately applied to active and reactive power components of the measured total power in the first area of the power grid to obtain active and reactive power components of the forced and/or natural oscillating power. The measurement of oscillating power described herein does not require any distinguishing between the two types of oscillation, nor prior knowledge of their oscillating frequency, nor determining a location of the source of the original forced oscillations. Optionally, the cut-off frequency of the low pass filter is less than a predetermined minimum frequency of the forced and/or natural oscillations.

Optionally, the method further comprises obtaining one or both of active and reactive power reference values based on one or both of the corresponding active and reactive power components of forced oscillating power, wherein the converter is controlled based on one or both of the corresponding active and reactive power reference values.

Optionally, the active power reference value comprises a sum of i) a maximum wind power reference value, which is based on a measurement of the rotational speed of the rotating wind turbine blades, and, ii) the measured active forced oscillation power.

Optionally, the measurement of the rotational speed of the rotating wind turbine blades is averaged over a time period. Advantageously, utilising an averaged rotational speed of the rotating wind turbine blades causes a smoothing of the active power reference value and therefore the wind turbine system is prevented from becoming a forced oscillation source and exciting existing forced oscillations.

Optionally, the active and reactive components of the reference power value are based on an available power converter capacity headroom above a current operating point of the power converter in the wind turbine system and the real-time rotational speed of the wind turbine system. The power converter capacity headroom is an amount of capacity between the maximum wind power that could be utilized by the wind turbine system and the amount that is actually utilized.

Optionally, the wind turbine system is one of a plurality of communicatively connected wind turbine systems in a wind farm configured to provide load power into the power grid, and wherein the active and reactive power reference values are based on the number of the plurality of wind turbine systems in the wind farm. The wind turbines may be communicatively connected via a wired or wireless datalink. The wind turbine system may alternatively be one of a plurality of non-communicatively connected wind turbine systems.

Optionally, the power converter is a back-to-back converter comprising a rotor-side converter connected directly to the generator and a grid-side inverter connected to the grid, wherein the rotor-side converter and grid-side inverter are connected by a DC link, and wherein the grid-side converter is controlled to providing the corrective oscillating power.

The method of isolating or suppressing forced oscillations in a power grid by utilising a wind turbine system may be under either grid-following or grid-forming control principles. Under grid-following control principled, the converter outputs power to the grid based on measurements of the voltage and current of the grid. Under grid-forming control, the converter outputs power to the grid based on a frequency, phase, and amplitude that is generated within the converter itself.

Optionally, the power converter is configured to generate an output frequency, phase, and amplitude of power supplied to the grid in order to function as a grid-forming converter.

According to a second aspect of the invention there is provided a wind turbine system for supplying electricity to a power grid whilst suppressing forced oscillating power in the power grid, the wind turbine system configured comprising a power converter configured to carry out the method as discussed above.

Optionally, the generator is one of any of a doubly-fed induction generator, a permanent magnet synchronous generator, other power electronics-interfaced variable speed wind turbine system with induction generator, and synchronous generator.

According to a third aspect of the invention there is provided an electricity generation system comprising a first generator in a first area of a power grid, a second generator in a second area of the power grid, and a wind turbine system configured to carry out the method discussed above, wherein the wind turbine system is configured to inject corrective oscillating power into the power grid between the first and second areas thereby suppressing or isolating forced oscillating power generated by the first generator within the first area.

According to a fourth aspect of the invention there is provided a method for measuring forced and/or natural oscillating power in an area of a power grid, the method comprising: measuring total oscillating power transmitted from the area of the power grid to another area of the power grid at the connection point of a wind turbine system; applying a low pass filter to measurements of the total oscillating power to obtain measurements of forced and/or natural oscillating power; wherein the low pass filter is separately applied to active and reactive power components of the measured total oscillating power to obtain active and reactive components of the forced and/or natural oscillating power; and wherein the low-pass filter has a cut-off frequency that is less than a predefined minimum frequency of forced and/or natural oscillations.

The skilled person will appreciate that except where mutually exclusive, a feature described in relation to any one of the aspects, examples or embodiments described herein may be applied to any other aspect, example, embodiment or feature. Further, the description of any aspect, example or feature may form part of or the entirety of an embodiment of the invention as defined by the claims. Any of the examples described herein may be an example which embodies the invention defined by the claims and thus an embodiment of the invention.

The discussed suppression method for Forced oscillations utilises Wind Turbine systems incorporating power converters running under either a grid-following or grid-forming scheme. The proposed method can also use Inverter Based Resources (IBR) and/or Converter Interfaced Generation (CIG).

### BRIEF DESCRIPTION OF THE DRAWINGS

Various embodiments of the invention will now be described with the aid of the following drawings in which:

FIG. 1 shows a two-machine system with a wind farm, WF, for illustrating the discussed method.

FIG. 2 shows an equivalent circuit for the two-machine system of FIG. 1, with the WF modelled as a controlled current source.

FIG. 3 shows bode diagrams resulting from an example transfer function relating to the equivalent circuit shown in FIG. 2.

FIG. 4 shows the relationship between coefficients relating to the suppression of forced oscillations vs the electrical distance of the wind farm to the first generator SG1 of FIG. 1 under two operation conditions.

FIG. 5 shows the transfer function gain vs the distance of the wind farm to the first generator SG1 of FIG. 1 under two operating conditions.

FIG. 6 shows a schematic representation of the control structure of a wind turbine control system.

FIG. 7 shows a schematic representation of an example power grid incorporating the wind turbine system of the present invention.

FIG. 8 shows the real-time wind speed for an example wind turbine system according to a first scenario.

FIGS. 9(a)-(k) shows simulation results in connection with the example system from FIGS. 6 to 8.

FIG. 10 shows the real-time wind speed for an example wind turbine system according to a different simulation.

FIGS. 11(a)-(g) shows simulation results in connection with the example system of FIGS. 6, 7, and 10.

FIGS. 12(a)-(d) shows simulation results for a scenario simulation of the control system and power grid of FIGS. 6 and 7 respectively.

FIG. 13 shows a schematic representation of the control structure of a wind turbine utilising a grid-forming principle of operation.

FIGS. 14(a) and 14(b) show a comparison of simulation results of the wind turbine systems of FIGS. 6 and 13, when incorporated into the power grid of FIG. 7.

FIG. 15 shows a flow diagram indicating an example method according to this disclosure.

### DETAILED DESCRIPTION

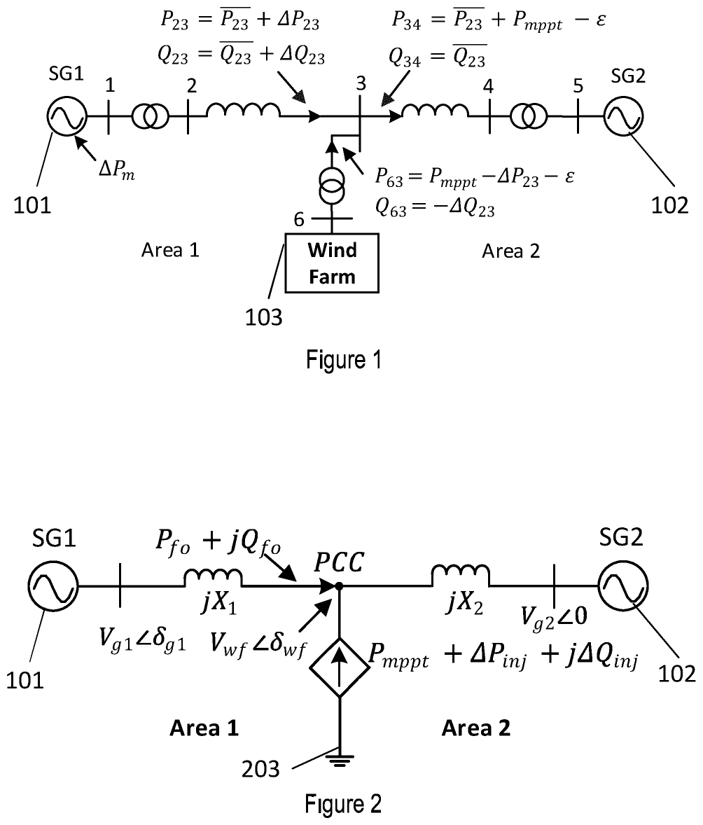

A method according to this disclosure is initially described as operating using a two-machine system with a wind farm 103 represented in FIG. 1. However, this manner of operating the method is exemplary and the method could be implemented using alternative systems. With reference to FIG. 1, a first synchronous generator 101 is located in a first area “Area 1” of a grid system. A second synchronous generator 102 is located in a second area “Area 2” of a grid system. The synchronous generators may be any type of rotational electricity generator. The first/second areas, and wind farm are joined at bus 3 (or “Point of Common Coupling (PCC)). Bus 3 can also be considered as a boundary between the Area 1 and Area 2. An external disturbance ΔPₘ, such as a periodic disturbance as described above, can occur in Area 1. The external disturbance ΔPₘ causes forced oscillations (which may be referred to as forced oscillating power) to enter the system. Typically, the forced oscillations resulting from the disturbance are at a natural frequency ωₙ of the system.

The external disturbance ΔPₘ may cause active and reactive components of forced oscillations ΔP₂₃ and ΔQ₂₃. In other examples, the forced oscillations may only comprise active or reactive power. As used herein, terms Pᵢⱼ and Qᵢⱼ represent active and reactive power respectively that is transferred between buses i and j. With reference to Area 1 of FIG. 1, P₂₃ and Q₂₃ represent total power that is transferred between bus 2 and bus 3. Each of P₂₃ and Q₂₃ include i) P̅₂̅₃̅ and Q̅₂̅₃̅ representing ideal power values generated by generator 101 (excluding forced oscillating power), and, additionally include ii) forced oscillating power ΔP₂₃ and ΔQ₂₃. The ideal power values may be calculated by applying a low-pass filter to P₂₃ and Q₂₃. The values of forced oscillating power ΔP₂₃ and ΔQ₂₃ may be obtained at bus 3 by measuring P₂₃ and Q₂₃ and extracting measurements of forced oscillating power ΔP₂₃ and ΔQ₂₃ by applying the low-pass filter to P₂₃ and Q₂₃. An objective of the disclosed method is to suppress the oscillating power ΔP₂₃ and ΔQ₂₃, and, to isolate the oscillating power ΔP₂₃ and ΔQ₂₃ within Area 1.

The active and reactive power generated by generator 101 can be represented by the following equations:

$${P}_{23} = \overline{{P}_{23}} + Δ {P}_{23} \qquad ( 1 a )$$

$${Q}_{23} = \overline{{Q}_{23}} + Δ {Q}_{23} \qquad ( 1 b )$$

The wind farm may comprise wind turbine systems that are operated under “Maximum power Point Tracker” (MPPT) control. Pₘₚₚₜ is the power output of the wind farm under MPPT control. MPPT control of a wind turbine is control of the rotational speed of wind turbine blades and/or pitch angle of wind turbine blades to generate an optimal amount of power based on local wind conditions. The rotational speed of wind turbine blades can be controlled by varying a load/torque applied to a wind turbine generator. When wind turbine blades are rotating at a maximum rotational velocity, pitch angle control is utilised to prevent the blades from exceeding the maximum rotational velocity.

P₆₃ and Q₆₃ are active and reactive power values respectively representing the power that is transferred from the wind farm 103 to the grid system (i.e. between bus 6 and 3). The wind farm 103 provides Pₘₚₚₜ of active power for providing electrical power to the system thereby undertaking its primary purpose. Advantageously, utilising the methods disclosed herein, the wind farm 103 additionally provides corrective oscillating active and reactive power −ΔP₂₃ and −ΔQ₂₃ which is inverse to the oscillating power ΔP₂₃ and ΔQ₂₃. The wind farm 103 does not necessarily generate both active and reactive power.

ε represents a loss of wind power capture utilising the disclosed methods. As will be discussed with reference to simulation results below, ε is very small and can be neglected.

Therefore, the power provided by the wind farm 103 to the grid at bus 3 can be represented using the following equations:

$${P}_{63} = {P}_{mppt} - Δ {P}_{23} - ε \qquad ( 1 c )$$

$${Q}_{63} = - Δ {Q}_{23} \qquad ( 1 d )$$

Bus 3 can be considered a boundary between Area 1 and Area 2 of the grid as shown in FIG. 1. An aim of the disclosed method is to reduce or even prevent forced oscillations from crossing said boundary from Area 1 to Area 2.

With continued reference to FIG. 1, the wind farm 103 injects additional corrective oscillating active and reactive power thereby isolating the forced oscillations in Area 1. The active and reactive power injected by the wind farm 103 are given by:

$$Δ {P}_{i n j} = - Δ {P}_{23} \qquad ( 1 )$$

$$Δ {Q}_{i n j} = - Δ {Q}_{23} \qquad ( 2 )$$

P₃₄ and Q₃₄ are active and reactive power values respectively that represent power that is transferred between bus 3 and bus 4. Due to the power input from the wind farm 103 as per equations 1c and 1d, P₃₄ and Q₃₄ do not include forced oscillating power ΔP₂₃ and ΔQ₂₃.

Therefore, P₃₄ and Q₃₄ are given by:

$${P}_{34} = {P}_{23} + {P}_{63} = \overline{{P}_{23}} + {P}_{mppt} - ε \qquad ( 3 )$$

$${Q}_{34} = {Q}_{23} + {Q}_{63} = \overline{{Q}_{23}} \qquad ( 4 )$$

In this way, P₃₄ and Q₃₄ being injected into Area 2 do not contain forced oscillating power components. P₃₄ and Q₃₄ only comprise the ideal power values P̅₂̅₃̅ and Q̅₂̅₃̅, power generated by the wind farm 103 under MPPT control Pₘₚₚₜ, and, losses ε which are normally small in practice. Therefore, the transmission line between bus 2 and bus 3 becomes an effective isolation wall through which the forced oscillations do not propagate. The forced oscillations are only contained in Area 1. When the forced oscillations in Area 1 are isolated and prevented from transmitting to Area 2, the oscillations in Area 1 are also suppressed.

Advantageously, since the method and system described above does not need prior knowledge of frequencies of the forced oscillations, the method and system is able to respond to any power fluctuations, not only the forced oscillations but also natural oscillations including inter-area oscillations.

Advantageously, as can be seen from FIG. 1, if the wind farm 103 is closer to the source of forced oscillations (e.g. generator 101), a larger area (e.g. Area 2) will be immune from forced oscillations and the excited oscillating power output of generator 101 will be smaller. When the wind farm 101 is further away from the source of forced oscillations, the disclosed method will still be able to restrict the forced oscillation to be within the area bounded by the location of the wind farm 103 installation (e.g. Area 1). Only local power measurements are required from the selected isolation wall (e.g. bus 3) for the disclosed method regardless of the location of the wind farm 101.

In order to help understand the present disclosure, a method and system when there is no corrective power injected, i.e. ΔPᵢₙⱼ and ΔQᵢₙⱼ are zero and the wind farm 103 is not controlled to isolate and suppress Forced Oscillations is first described. In this case, it is helpful to refer to FIG. 2 representing an equivalent circuit for the two-machine system of FIG. 1 with the wind farm modelled as a controlled current source 203. This model and equations 5 to 26 below are presented here as being useful for understanding the effects of the method.

With reference to FIG. 2, when ΔPᵢₙⱼ and ΔQᵢₙⱼ are zero, the active and reactive power transfers can be written as:

$${P}_{fo} = \frac{{V}_{g 1} {V}_{w f} sin ( {δ}_{g 1} - {δ}_{w f} )}{{X}_{1}} , {Q}_{fo} = \frac{{V}_{g 1} {V}_{w f} cos ( {δ}_{g 1} - {δ}_{w f} ) - {V}_{w f}^{2}}{{X}_{1}} \qquad ( 5 )$$

$${P}_{fo} + {P}_{mppt} = \frac{{V}_{w f} {V}_{g 2} sin {δ}_{w f}}{{X}_{2}} \qquad ( 6 )$$

Where:
P_{fo}=Active forced oscillating power
Q_{fo}=Reactive forced oscillating power
Pₘₚₚₜ=Power generated by wind farm at MPPT control
V_{g1}=Voltage amplitude at the bus connected to Synchronous Generator 101
V_{g2}=Voltage amplitude at the bus connected to Synchronous Generator 102
V_{wf}=Voltage amplitude at the bus connected to wind farm
δ=Voltage phase angle relative to a reference voltage phase angle
X₁=Effective reactance between SG1 and PCC
X₂=Effective reactance between SG2 and PCC

These equations are obtained using the concepts discussed, for example, on page 20 of P. Kundur, N. J. Balu, and M. G. Lauby, Power system stability and control. McGraw-hill New York, 1994, incorporated by reference herein.

Linearizing equations (5) and the rotor equations of SG1 provides the following equations:

$${M}_{1} \frac{d ( {Δω}_{g 1} )}{dt} = Δ {P}_{m} - Δ {P}_{fo} - {D}_{1} Δ {ω}_{g 1} \qquad ( 7 )$$

$$\frac{d ( {Δδ}_{g 1} )}{dt} = {ω}_{b} Δ {ω}_{g 1} \qquad ( 8 )$$

$$Δ {P}_{fo} = {K}_{P δ} {δ}_{g 1} \qquad ( 9 )$$

$$Δ {Q}_{fo} = {K}_{Q δ} Δ {δ}_{g 1} \qquad ( 10 )$$

$$Where$$

$${K}_{P δ} = \frac{{V}_{g 10} {V}_{w f 0} cos ( {δ}_{g 10} - {δ}_{w f 0} )}{{X}_{1}} [ 1 - \frac{{X}_{2} {V}_{g 10} cos ( {δ}_{g 10} - {δ}_{w f 0} )}{{X}_{1} {V}_{g 20} cos {δ}_{w f 0} + {X}_{2} {V}_{g 10} cos ( {δ}_{g 10} - {δ}_{w f 0} )} ] \qquad ( 11 )$$

$${K}_{Q δ} = - \frac{{V}_{g 10} {V}_{w f 0} sin ( {δ}_{g 10} - {δ}_{w f 0} )}{{X}_{1}} [ 1 - \frac{{X}_{2} {V}_{g 10} cos ( {δ}_{g 10} - {δ}_{w f 0} )}{{X}_{1} {V}_{g 20} cos {δ}_{w f 0} + {X}_{2} {V}_{g 10} cos ( {δ}_{g 10} - {δ}_{w f 0} )} ] \qquad ( 12 )$$

In (7)-(8), M₁ and D₁ are inertia constant and damping factors, respectively, of generator 101. ω_{b} is the base angle electrical speed in radians per second. In (11)-(12) the subscript 0 represents the corresponding variables at steady state.

Combining (7)-(10), transfer functions G_{Pfo}(s) and G_{Qfo}(s) from ΔPₘ to ΔP_{fo} and ΔQ_{fo} respectively, (i.e. to obtain the active and reactive components of the forced oscillating power from the disturbance at generator 101 shown in FIG. 1) can be obtained:

$${G}_{Pfo} ( s ) = \frac{{ω}_{b} {K}_{P δ}}{{M}_{1} {s}^{2} + {D}_{1} s + {ω}_{b} {K}_{P δ}} = \frac{{ω}_{n}^{2}}{{s}^{2} + 2 ζ {ω}_{n} s + {ω}_{n}^{2}} \qquad ( 13 )$$

$${G}_{Qfo} ( s ) = \frac{{K}_{Q δ}}{{K}_{P δ}} {G}_{P 0} ( s ) \qquad ( 14 )$$

where ωₙ and ζ are the undamped natural frequency and damping ratio of G_{Pfo}(s) and G_{Qfo}(s), given by:

$${ω}_{n} = \sqrt{\frac{{ω}_{b} {K}_{P δ}}{{M}_{1}}} \qquad ( 15 )$$

$$ζ = \frac{1}{2} \frac{{D}_{1}}{\sqrt{{ω}_{b} {M}_{1} {K}_{P δ}}} \qquad ( 16 )$$

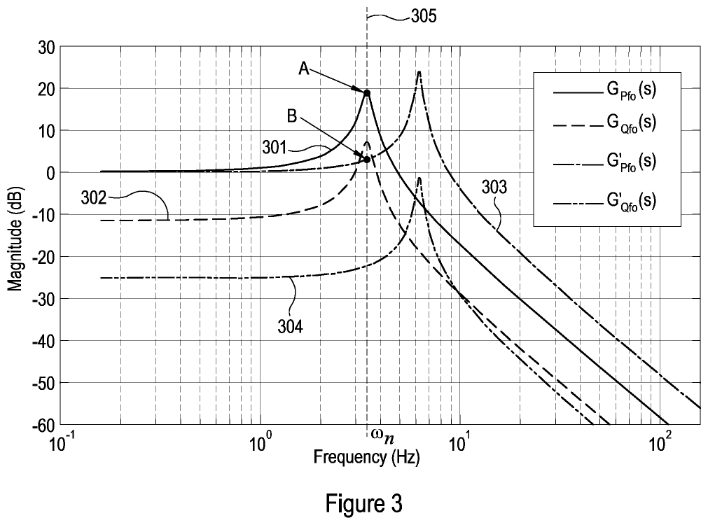

FIG. 3 utilises equations 13 and 14 to show a bode plot illustrating the frequency response curves for active and reactive power transfer functions G_{Pfo}(s), 301, and G_{Qfo}(s), 302 where the damping factor D₁ is deliberately set large as 10 p.u and M₁ is set as 4 p.u. Furthermore: ω_{b}=377 rad/s, X₁=0.06p.u., X₂=0.14p.u., V_{g10}=V_{wf0}=V_{g20}=1p.u., P_{g10}=0.9p.u., P_{wf0}=0.6p.u. The frequency response curves represent the magnitude response of the forced oscillation at bus 3 relative to the external disturbance ΔPₘ in FIG. 1 (or PCC in FIG. 2). When the magnitudes of the frequency response curves are greater than 0, then the forced oscillations are being amplified. When the magnitudes of the frequency response curves are less than 0, then the forced oscillations are being attenuated. As discussed above, forced oscillating power normally occurs at the natural frequency of the system ωₙ. It is therefore particularly desirable to minimise the frequency response at ωₙ. It can be seen that around the undamped natural frequency can at line 305, the magnitudes of functions 301 and 302 become much larger than 0, which means that large-amplitude oscillations (forced oscillations) occur despite the use of a relatively large positive damping factor D₁. Furthermore, it can be seen that the magnitude of G_{Pfo}(s) is much larger than that of G_{Qfo}(s), which means that forced oscillations are mainly associated with the active power.

The largest magnitude of G_{Pfo}(s) at ωₙ is given by:

$$\vert {G}_{Pfo} ( j {ω}_{n} ) \vert = \frac{1}{2 ζ} = \frac{\sqrt{{ω}_{b} {M}_{1} {K}_{P δ}}}{{D}_{1}} \qquad ( 17 )$$

Equation (17) shows that the magnitude of the excited forced oscillations can be reduced by increasing damping D₁, or decreasing inertia constant M₁. The forced oscillations cannot be eliminated unless D₁ is infinite (which is impossible), or the external disturbance ΔPₘ is removed (which is difficult or impossible to achieve). The methods disclosed herein utilise wind farms to inject corrective power (particularly active power) to isolate and suppress forced oscillations.

A particularly advantageous system and method is described below to address the problems discussed above in relation to forced oscillations.

With returned reference to FIG. 2, the injection of corrective oscillating power ΔPᵢₙⱼ and ΔQᵢₙⱼ cause a change of amplitude and angle of the bus voltage at the current source 203 (representing the wind farm 103) V_{wf}∠δ_{wf}. This change can be represented by the following equations:

$${Δ V}_{w f} \approx \frac{{X}_{1} {X}_{2}}{( {X}_{1} + {X}_{2} ) {V}_{w f 0}} Δ {Q}_{i n j} , Δ {δ}_{w f} \approx \frac{{X}_{1} {X}_{2}}{( {X}_{1} + {X}_{2} ) {V}_{w f 0}^{2}} Δ {P}_{i n j} \qquad ( 18 )$$

Using the superposition principle, new ΔP_{fo}′ and ΔQ_{fo}′ under the impact of ΔPₘ and ΔPᵢₙⱼ and ΔQᵢₙⱼ are given by:

$$Δ {P}_{fo}^{′} = {K}_{P δ} Δ {δ}_{g 1} - {K}_{PP} Δ {P}_{i n j} - {K}_{P Q} Δ {Q}_{i n j} \qquad ( 19 )$$

$${ΔQ}_{fo}^{′} = {K}_{Q δ} Δ {δ}_{g 1} - {K}_{Q P} Δ {P}_{i n j} - {K}_{Q Q} Δ {Q}_{i n j} \qquad ( 20 )$$

where K_{PP}, K_{PQ}, K_{QP}, and K_{QQ} are:

$${K}_{P P} = \frac{( 1 - a ) {V}_{g 10} cos ( {δ}_{g 10} - {δ}_{w f 0} )}{{V}_{w f 0}} \qquad ( 21 )$$

$${K}_{P Q} = - \frac{( 1 - a ) {V}_{g 10} sin ( {δ}_{g 10} - {δ}_{w f 0} )}{{V}_{w f 0}} \qquad ( 22 )$$

$${K}_{Q P} = - \frac{( 1 - a ) {V}_{g 10} sin ( {δ}_{g 10} - {δ}_{w f 0} )}{{V}_{w f 0}} \qquad ( 23 )$$

$${K}_{Q Q} = 2 ( 1 - a ) - \frac{( 1 - a ) {V}_{g 10} cos ( {δ}_{g 10} - {δ}_{w f 0} )}{{V}_{w f 0}} \qquad ( 24 )$$

where a=X₁/(X₁+X₂), representing the electrical distance of the current source 203 (or wind farm 103) to the generator 101.

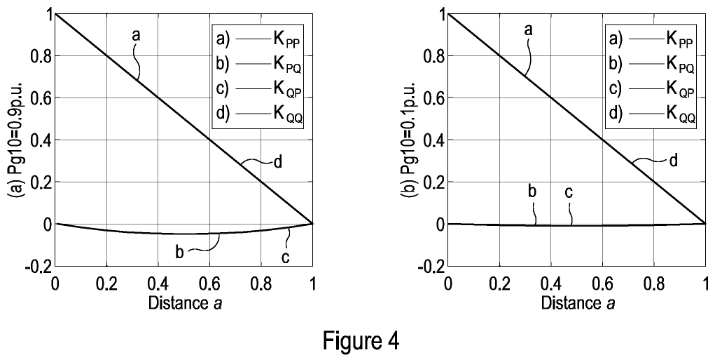

The coefficients shown in (21)˜(24) with changing a (i.e., changing electrical distance of the wind farm 103 to the generator 101) are shown in FIG. 4 under two operating conditions of power generated by SG1 at steady state conditions P_{g10}=0.9p.u. and P_{g10}=0.1p.u. Furthermore: M₁=4p.u., D₁=10p.u., ω_{b}=377 rad/s, X₁+X₂=0.2p.u., V_{g10}=V_{wf0}=V_{g20}=1p.u. (a) P_{g10}=0.9p.u. (b) P_{g10}=0.1p.u. It can be seen from FIG. 4 that both K_{PQ}, K_{QP} are very small compare with K_{PP} and K_{QQ} under two operating conditions, indicating the little effect of ΔQᵢₙⱼ and ΔPᵢₙⱼ on the forced oscillating power ΔP_{fo}′ and ΔQ_{fo}′, respectively. K_{PP} and K_{QQ} in FIG. 4 demonstrate that the effect of the discussed method for suppressing forced oscillating power is more effective when the wind farm 103 is located closer to the source of forced oscillations at the generator 101. Where there appears to be a single curve labelled by two references in any figure, e.g. K_{PP} and K_{QQ} in FIG. 4, there is intended to be represented two separate curves that substantially overlay one another.

Ignoring K_{pQ} and K_{QP}, combining (7)-(8) and (19)-(20), the frequency response of active and reactive power at bus 3 to the forced oscillating power (from ΔPₘ to ΔP_{fo}′ and ΔQ_{fo}′) are given by

$${G}_{Pfo}^{′} ( s ) = \frac{{ω}_{b} {K}_{P δ}}{( 1 - {K}_{P P} ) ( {M}_{1} {s}^{2} + {D}_{1} s ) + {ω}_{b} {K}_{P δ}} = \frac{{ω}_{n}^{2}}{( 1 - {K}_{P P} ) ( {s}^{2} + 2 ζ {ω}_{n} s ) + {ω}_{n}^{2}} \qquad ( 25 )$$

$${G}_{Qfo}^{′} ( s ) = \frac{( 1 - {K}_{P P} ) {K}_{Q δ}}{( 1 - {K}_{Q Q} ) {K}_{P δ}} {G}_{P} ( s ) \qquad ( 26 )$$

The bode plots of G_{Pfo}′(s) 303 and G_{Qfo}′(s) 304 are also shown in FIG. 3. Comparing G_{Pfo}′(s) 303 in (25) (utilising corrective oscillating power) with G_{Pfo}(s) 301 in (13) (not utilising corrective oscillating power) it can be seen from FIG. 3 that the magnitude of Forced Oscillations of active power at the natural frequency ωₙ is decreased from point A to point B, meaning that the forced oscillations in area 1 are significantly suppressed. It can also be seen that there remains a positive peak in the active power response curve 303. However, this peak is at a significantly higher frequency than the natural frequency ωₙ at which forced oscillations normally occur and is therefore of little concern. Furthermore, the frequency response curve for reactive power 302 is reduced to curve 304, which is below zero at all frequencies thereby indicating suppression (and even attenuation) of forced oscillating reactive power.

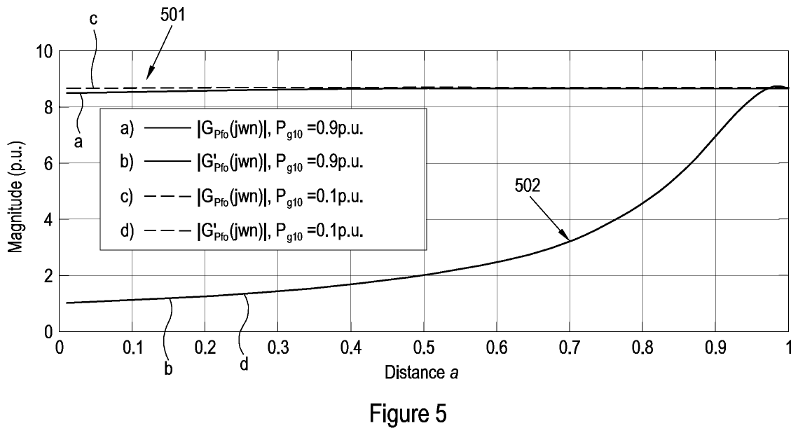

FIG. 5 shows |G_{Pfo}′(jωₙ)| 502 and |G_{Pfo}(jωₙ)| 501 in relation to the electrical distance a of the wind farm 103 to generator 101 under two operating conditions where P_{g10}=0.9p.u. and P_{g10}=0.1p.u. The curves for each operating condition of SG1 are effectively superimposed, meaning that the operating condition of SG1 has little effect on the amplitude of the excited forced oscillations. It can be seen that with lower a, the suppression effect of forced oscillations in a particular area, such as area 1 of FIG. 1, is improved because the frequency response magnitude of the forced oscillations to the external disturbance source is lower. This means that choosing multiple WFs in an interconnected power system to enclose forced oscillations to be within a smaller area can not only result in a bigger area that is immune from forced oscillations, but also can better suppress the forced oscillations that are excited within a particular area.

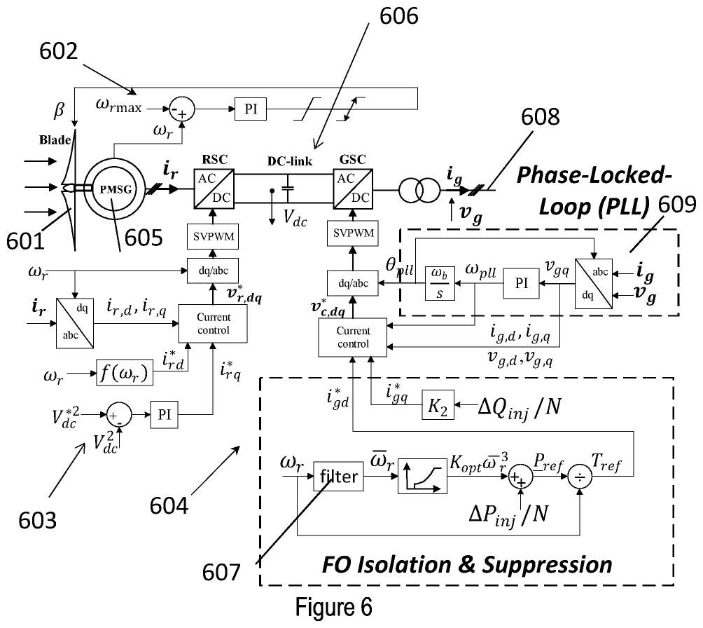

With reference to FIG. 6, there is an example configuration and control structure of a permanent-magnet synchronous generator (PMSG)-based wind turbine system (WTS) for implementing the discussed Forced Oscillation isolation and suppression method. The shown variables are defined as follows: Iᵣ, Vᵣ, I_{g}, V_{g}: current and voltage measured at rotor side and grid side, i_{rd}*, i_{rq}*, i_{gd}*, i_{gq}*: current references, V_{dc}*, V_{dc}: DC-link voltage reference and measured value, β: pitch angle, ωₘₐₓ, ωᵣ: the maximum and real-time rotor speed, K₁, K₂: constants, ΔPᵢₙⱼ, ΔQᵢₙⱼ: given by equations (1) and (2). The discussed method could also be implemented using other types of wind turbine system such as a doubly fed induction generator (DFIG)-based WTS, other power electronics-interfaced variable speed wind turbine system with induction generator, and synchronous generator (not shown).

The wind turbine system of FIG. 6 is suitable for following a grid-following control principle and is suitable for performing methods disclosed herein and generating power from a set of wind turbine blades 601 via a PMSG generator 605 and back-to-back converter 606. Generated power is supplied to a power grid via a connection at 608. Alternative types of wind turbine system could be utilised to implement the discussed methods.

A controller 604 obtains forced oscillating power via processing the oscillating power which is transferred from area 1 to area 2 in and measured at PCC in FIG. 1. Typically, the forced oscillating power includes active and reactive components ΔPᵢₙⱼ and ΔQᵢₙⱼ. The controller 604 controls grid-side converter GSC of a converter 606 located in series between the generator 605 driven by wind turbine blades 601 and the grid to provide corrective oscillating power that is inverse to the measured forced oscillating power. The converter 606 supplies load power generated by the generator 605 to the power grid. The converter 606 also injects corrective oscillating power to the power grid such that the corrective oscillating power suppresses the forced oscillating power in the grid. The converter may be back-to-back converter 606 comprising a rotor-side converter RSC and a grid-side converter GSC attached via a DC link.

A wind turbine 601 captures power from wind and drives the PMSG generator 605. Typically, the controller 604 controls, via the converter 606 the rotational speed of the wind turbine depending on the wind speed of air flowing through the wind turbine. Therefore, the generator is driven to generate load power for supplying the grid, and, for generating an active component of the corrective oscillating power for injecting into the grid.

The rotational speed of the wind turbine 601 may be controlled based on MPPT control. During MPPT control, the rotational speed of the wind turbine 601 is controlled at an optimal value and increases with wind speed (up to the so-called rated wind speed) depending on a predefined relationship. At the rated wind speed, the rotational speed of the wind turbine is at a maximum (ωₘₐₓ). At wind speeds higher than the rated wind speed, the pitch angle of the blades of the wind turbine are adjusted to extract power from the wind whilst maintaining the rotational speed of the wind turbine at ωₘₐₓ. If the wind speed reaches an even higher “cut-off” value, then the wind turbine blades cannot be maintained at ωₘₐₓ by utilising pitch angle control and must be stopped for safety.

In the example of FIG. 6, a pitch-angle controller 602 is used to limit the rotor speed under high wind speed above the rated wind speed discussed above and becomes effective when the real-time rotor speed is greater than the maximum rated rotor speed (ωᵣ>ωₘₐₓ). For the sake of the calculations set out in this disclosure, ωₘₐₓ=1 p.u.

The controller 604 may process the measurements of forced oscillations ΔPᵢₙⱼ and ΔQᵢₙⱼ, and the real time rotational speed of the wind turbine ωᵣ and accordingly control, via the converter 606, the rotational speed of the wind turbine 601 in order to extract inertial kinetic energy from the wind turbine for providing an active component of corrective oscillating power. In effect, ωᵣ is slightly oscillating so that the kinetic energy is utilized to generate the corrective oscillating active power. Typically, kinetic energy is utilized from the wind turbine 601 only when the wind speed is below the rated wind speed.

When the wind speed is above the rated wind speed, corrective oscillating active power can be extracted from the external wind energy by adjusting the pitch angle of the wind turbine blades whilst maintaining the rotational speed of the wind turbine at ωₘₐₓ.

The current controller 604 can also control generation of reactive corrective oscillating power for injecting to the grid. The converter 606 is typically able to generate reactive power independently from the active power generation, typically without relying on the rotation of the wind turbine 601.

The injection of active and/or reactive corrective oscillating power into the grid as discussed above is typically undertaken by the back-to-back converter 606, and more specifically, the grid-side converter GSC.

The grid side converter GSC may also be utilised to smooth oscillating wind power caused by variable wind speed that could excite forced oscillations by applying a low-pass filter 607 to the real time rotational speed ωᵣ.

The grid-side converter GSC may utilise a phase-locked-loop (PLL) component 609 to track the grid voltage frequency and angle, so that the generated voltage of the GSC is synchronized to the grid voltage. In this instance, the WTS of FIG. 6 is controlled based on “grid-following” control principle. Under grid-following control principle, a WTS does not actively regulate system voltage without extra auxiliary control loops.

The rotor side converter RSC of the system of FIG. 6 is normally utilised to stabilise voltage in the DC-link between the RSC and GSC, and further, to minimise reactive power output from the generator 605 to minimise power losses.

The current controller 604 may control power generation as discussed above by processing the real-time wind speed ωᵣ, active component of forced oscillating power ΔPᵢₙⱼ, reactive component of forced oscillating power ΔQᵢₙⱼ to produce power reference values of active power P_{ref} and reactive power Q_{ref}:

$${P}_{ref} = {K}_{opt} {\overline{ω}}_{r}^{3} + \frac{Δ {P}_{inj}}{N} \qquad ( 28 )$$

$${Q}_{ref} = \frac{Δ {Q}_{inj}}{N} \qquad ( 29 )$$

where Kₒₚₜ is the optimal coefficient, N is the total number of wind turbine systems in a wind farm, ΔPᵢₙⱼ and ΔQᵢₙⱼ are given by (1) and (2), and ω̅ᵣ is the average of ωᵣ through the low-pass filter 607. In (28), 1/N can also be replaced by

$$\frac{{ω}_{i}^{2} {S}_{Hi}}{{\sum }_{j = 1}^{N} {ω}_{j}^{2} {S}_{Hj}} ,$$

where ωᵢ and ωⱼ are rotor speeds, and S_{Hi} and S_{Hj} are the available capacity headroom above the current operating point of the grid-side converter of the i^{th} and j^{th} WTS.

The wind turbine system may be one of a plurality of wind turbine systems in a wind farm configured to inject power into the power grid, and the active and reactive components of the reference power values may be based on the number N of the plurality of wind turbine systems in the wind farm, for example, utilising equations 1/N or

$$\frac{{ω}_{i}^{2} {S}_{Hi}}{{\sum }_{j = 1}^{N} {ω}_{j}^{2} {S}_{Hj}} .$$

Typically, the power reference values are utilised by the current controller 604 to control the power generation of generator 605 in order to output power to the grid matching the power reference values.

Without generation of corrective oscillating power, the active and reactive power references are given by P_{ref}^{mppt}=Kₒₚₜωᵣ³ and Q_{ref}^{mppt}=0. Some advantages of the disclosed method of calculating power reference values are as follows:

Kₒₚₜω̅ᵣ³ gives a smoother power reference than Kₒₚₜωᵣ³ so that oscillating wind power output that could excite Forced Oscillations can be smoothed.

The components ΔPᵢₙⱼ/N and ΔQᵢₙⱼ/N in (28) and (29) respectively can make the wind turbine system generate corrective oscillating power opposite to Forced Oscillations on the adjacent transmission lines. Thus, these transmission lines become isolation walls (e.g. bus 3 in FIG. 1) through which the Forced Oscillations cannot propagate into other areas (e.g. preventing propagation from Area 1 into Area 2 in FIG. 1).

The generation and injection of forced oscillating power only causes the rotational speed of the wind turbine 601 to be slightly deviated from that under MPPT control without injection of corrective oscillating power. Therefore, almost-optimal wind power capture can also be realized, which will be demonstrated in the case studies discussed below.

Advantageously, under a high wind speed (above rated wind speed), when the pitch angle control is effective and ωᵣ is constant, the Forced Oscillations isolation and suppression method is also effective. In this case, the utilized energy comes from the external wind instead of the stored kinetic energy in a WTS.

With the higher penetration of wind power generation in power grids, the discussed method utilises the large kinetic energy of wind farms when the wind speed is below the rated wind speed, and, external wind energy when the wind speed is above the rated wind speed, for isolating and suppressing forced oscillations caused by forced oscillating power. With the discussed method the wind farm can timely release or absorb active and reactive power opposite to the oscillating power from the area containing forced oscillations (the disturbed area). As a result, the forced oscillations are prevented from propagating to the rest of the power grid, and the forced oscillations of the disturbed area that is bounded by the location of wind farm installation are also reduced (suppressed).

The discussed method utilises wind turbine systems to isolate and suppress forced oscillations. Thus, no extra energy storage and power electronic converters need to be installed. Simulation results demonstrated that the loss of wind power capture is negligible and the increase of the capacity of converters is small when the discussed method is used in wind turbine systems.

The discussed method can be easily implemented with only the information of the oscillating active and reactive power from the disturbed area, while a prior knowledge of frequencies of forced oscillations is not required.

Although the method is primarily for suppressing forced oscillations, it is also helpful to damp natural oscillations.

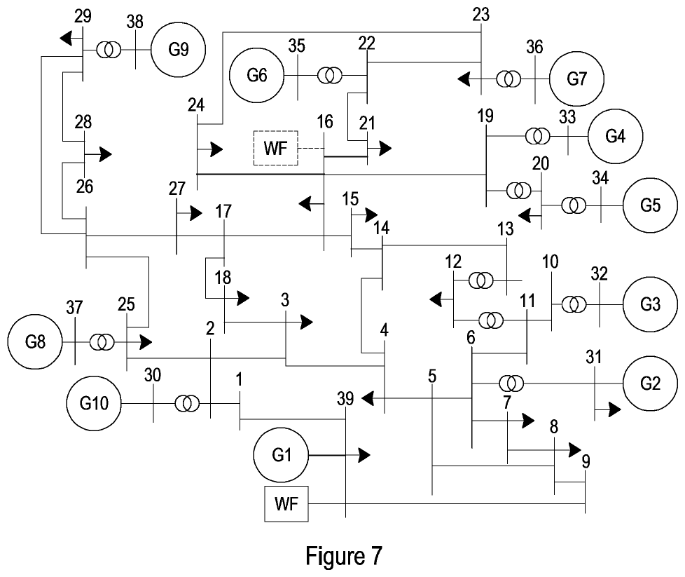

With reference to FIG. 7, a 39-bus system is used to investigate the performance of the disclosed method. The test system consists of ten synchronous generators (G1-G10), 39 buses, constant impedance loads and one aggregated PMSG-based wind farm (WF). The system parameters are obtained from I. Hiskens, “IEEE PES task force on benchmark systems for stability controls,” Tech. Rep. 39-bus system (New England reduced model), November 2013, where all the synchronous generators are equipped with a high transient gain thyristor exciter and a STAB1 PSS to ensure a good damping. The WF consists of 500 PMSG-based wind turbine systems (WTSs) under the grid-following control with variable wind speed input which is taken from “An aeroelastic computer-aided engineering tool for horizontal axis wind turbines”, Accessed: Mar. 19, 2015. [Online]. Available:https://nwtc.nrel.gov/FAST. The cut-in wind speed (the wind speed at which the wind turbine system can begin to generate power) is 6 m/s. The rated wind speed is 12 m/s. A 4th-order and 2th-order low-pass butterworth filter with cut-off frequency of 0.2 Hz are used to obtain ΔPᵢₙⱼ and ΔQᵢₙⱼ (28)(29), respectively. These types of filter may be utilised with the method discussed above. To obtain the average rotor speed of a WTS in (28) under the proposed strategy, a 2nd-order low-pass butterworth filter with cut-off frequency of 0.2 Hz is used. The cut-off frequency is normally determined based on relevant properties of the electrical components in the system such as oscillating modes. The frequency at which forced oscillations could be excited are normally known. The parameters of a PMSG-based WTS are provided in Table A below:

TABLE A
PARAMETERS OF A PMSG-BASED WTS

| Parameters | Value | | Parameters | Value | |
|---|---|---|---|---|---|
| Rated power | 2.0 | | Q-axis Unsaturated Magnet. | 1.0 | p.u. |
| | MVA | | Reactance | | |
| Rated stator | 4 | kV | Stator Resistance | 0.01 | p.u. |
| voltage | | | | | |
| Rated frequency | 3.77 | Hz | Magnetic Strength | 1.3 | p.u. |
| Inertia constant | 5.05 | s | Kₒₚₜ in (28) | 1.0 | p.u. |

| Pole pair Stator leakage | 11 0.1 | p.u. | $Captured wind power Pcap = \frac{1}{2} ρπ {R}^{2} {v}_{w}^{3} {C}_{ρ} ( λ , β ) = K {v}_{w}^{3} {C}_{ρ} ( {v}_{w} , {ω}_{r} , β ) ,$ |
|---|---|---|---|
| reactance | | | where K = 0.0012, v_{w} is in m/s, ωᵣ is in p.u. (when v_{w} = 12 m/s |
| D-axis Unsaturated | 0.65 | p.u. | ωᵣ = 1 p.u.), R = 81 m, and C_{ρ} ~ λ curve is adopted from [21]. |
| Magnet. Reactance | | | |

Moreover, active current of the RSC and GSC of the WTS is given priority and the total active and reactive current is limited within 1.2 p.u., i.e. when the total current is bigger than 1.2 p.u., active current reference is given as 1.2 p.u. while the reactive current reference is zero.

In the following, three case studies are carried out using the Dymola® simulation environment to demonstrate the effectiveness of the proposed method. In the following simulation results, Ti-j means transmission line between bus i and bus j and Pi,j means the transmitted power of Ti-j, the time x-axis is in the unit of seconds, and “@N” and “@Y” mean without and with the proposed strategy implemented, respectively.

Isolation and Suppression of Forced Oscillations with WF at Bus 39

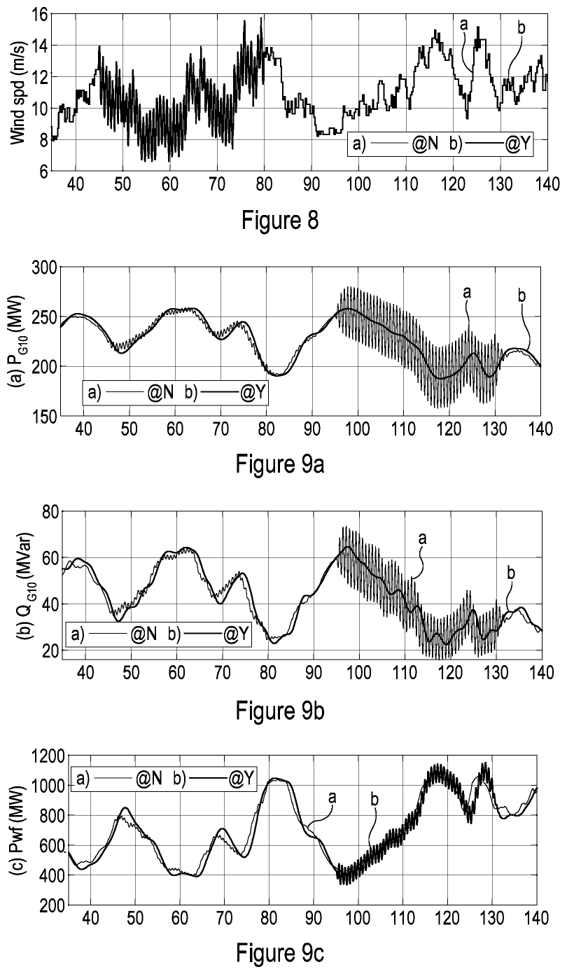

Case 1: In this case, the WF is located at bus 39 as shown in FIG. 7. The used variable wind speed input is shown in FIG. 8. A sinusoidal disturbance 1.5 sin(1.4*2πt) m/s is added to the variable wind speed from 45 s to 80 s. Thus, during 45 s˜80 s the WF becomes a Forced Oscillations source. During 95˜130 s, an external sinusoidal disturbance 0.04 sin(1.4*2πt) (0.04 p.u. is equal to 40 MW) is added to the mechanical torque of G1 at Bus 39 to cause Forced Oscillations. In this case, the active and reactive power from G1 are chosen to be smoothed by the WF under the disclosed strategy, i.e. −ΔP_{G1}& −ΔQ_{G1} are sent to the WF as ΔPᵢₙⱼ & ΔQᵢₙⱼ in (1)(2), respectively.

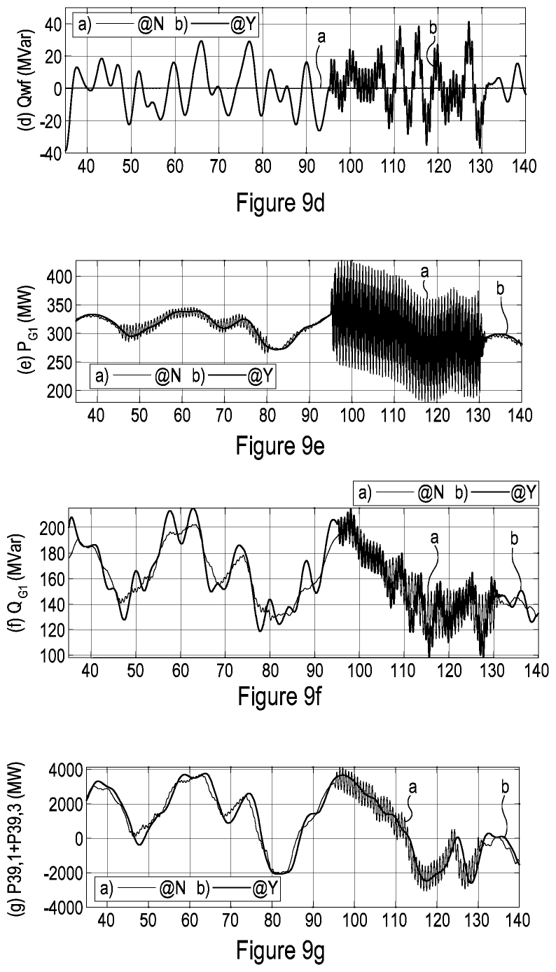

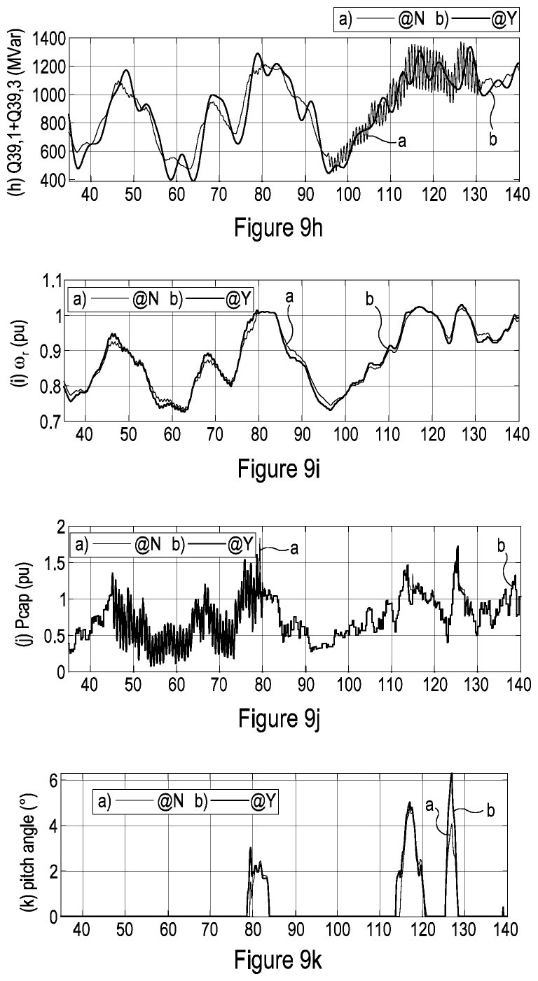

The simulation results for Case 1 are shown in FIGS. 9(a)-(k). During 95 s˜130 s, FIG. 9(a)-(b) show that without the proposed control scheme, both active and reactive power output of G10 at Bus 30 are oscillating with high amplitudes due to the Forces Oscillations from G1, FIG. 9(e)-(f), even when the system has good damping. The phenomenon verifies the conclusion from FIG. 3 and in S. Feng, X. Wu, P. Jiang, L. Xie, and J. Lei, “Mitigation of power system forced oscillations: an E-STATCOM approach,” IEEE Access, vol. 6, pp. 31599-31608, 2018 that the method of increasing damping to suppress Forces Oscillations is not effective. By contrast, FIG. 9(a)-(b) show that with the proposed method, the oscillating active and reactive power of G10 are reduced to zero during 95 s˜130 s. This is because the WF generates oscillating active and reactive power opposite to the oscillating active and reactive power from the Forced Oscillations source of G1 at bus 39, as seen from FIG. 9(c)-(d). Thus, the Forced Oscillations caused by G1 are contained (isolated) before Bus 39 and are not spreading beyond bus 39. This can be seen from FIG. 9(g)-(h) where the sum of the active and reactive power of T39-1 (which means transmission line between bus 39 and bus 1) and T39-9 is smoothed. At the same time, Forced Oscillations before bus 39 are also suppressed, which can be seen from FIG. 9(e)-(f), where active and reactive power oscillations in the output active and reactive power of G1 at bus 39 are also reduced. FIG. 9(i) shows the rotor speed with the proposed strategy is close to that without the proposed strategy due to the fact that the stored kinetic energy of a WTS is large compared to the energy required to smooth the oscillating active power output of G1. This means that no extra mechanical pressure is added on a WTS under the proposed strategy and the loss of wind power is negligible as can be seen from FIG. 9(j). FIG. 9(k) shows that during 95 s˜130 s there are periods when the pitch angle control is effective. This illustrates that the proposed strategy is also effective under wind speeds higher than the rated wind speed.

FIG. 9(c) and FIG. 9(d) show that during 95 s˜130 s the magnitude of the total oscillating power in Forced Oscillations frequency, i.e. \sqrt{ΔP_{wf}²+ΔQ_{wf}²} is around 50 MVA, so each WTS injects extra oscillating power of 0.1 MVA (50/500). Thus 4% extra capacity of the converters in a WTS is needed (4%=0.1 MVA/2.5 MVA since a WTS with 2.0 MW rated power is usually equipped with converters with 2.5 MVA rated capacity). This is practically feasible considering that the extra capacity is small, and the ongoing trend is that extra functions of grid services are required to be added into WTSs by grid codes, e.g. voltage and frequency regulation, which also unavoidably requires extra capacity of converters in WTSs.

During 45 s˜80 s, FIG. 9(c) shows that without the proposed strategy the WF generates oscillating wind power and is the Forced Oscillations source. Thus, the active and reactive power of G1 and G10 are oscillating, as can be seen from FIG. 9(a)-(b) and FIG. 9(e)-(f). However, with the proposed strategy FIG. 9(c) shows that the WF outputs smoothed active power by using the average instead of real-time rotor speed. Thus, the WF is no longer the Forced Oscillations source, which is demonstrated by the smoothed active and reactive power output of G1 and G10 shown in FIG. 9(a)-(b) and FIG. 9(e)-(f), respectively, and the smoothed active and reactive power of transmission lines of T39-1 and T39-9 shown in FIG. 9(g)-(h).

Isolation and Suppression of Forced Oscillations with WF at Bus 16

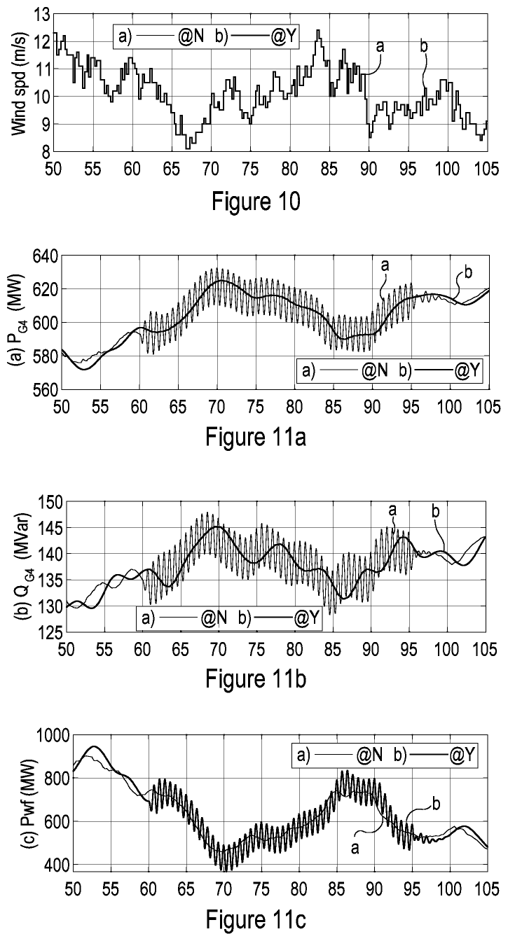

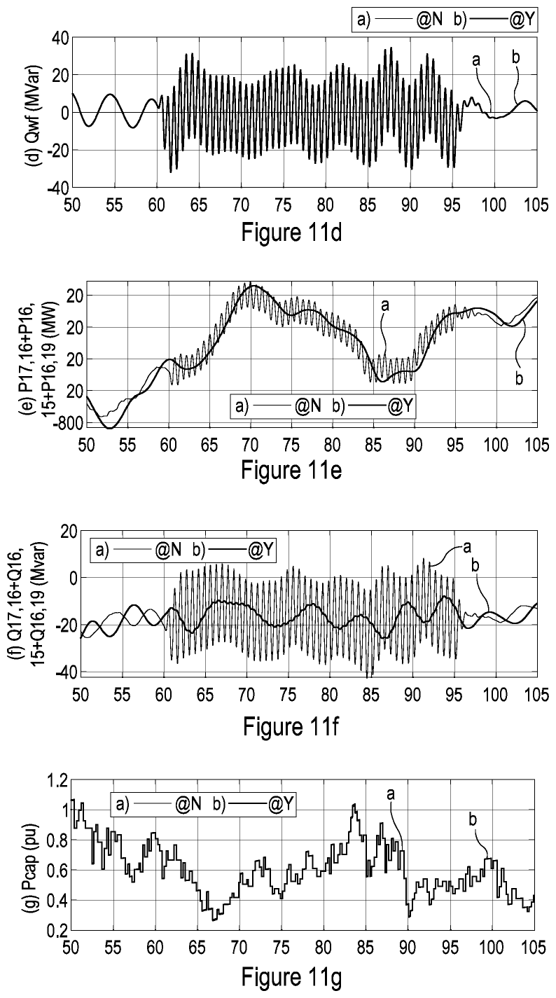

Case 2: In this case, an external sinusoidal disturbance 0.04 sin(1.4*2πt) p.u. is added to the mechanical torque of G7 during period of 60 s˜95 s to cause Forced Oscillations. The WF is located at bus 16 (see FIG. 7), which is further away from the source of Forced Oscillations—G7. In this case, transmission lines of T16-24 and T16-21 are chosen to be the isolation walls, i.e. the sum of the oscillating active and reactive power at transmission lines of T16-24 and T16-21 are sent to the WF. The proposed method prevents the Forced Oscillations from propagating beyond these two isolation walls. FIG. 10 shows the used variable wind speed input. FIGS. 11(a)-(g) show the simulation results for case 2.

Suppression of Inter-Area Oscillations with WF at Bus 16

Case 3: This case is simulated to verify that the proposed method can also help to damp inter-area oscillations. To excite inter-area oscillations, a three-phase fault with a duration of 100 ms is triggered at bus 23. Similar to Case 2, the WF is located at bus 16 (see FIG. 7) with a constant wind speed of 10 m/s.

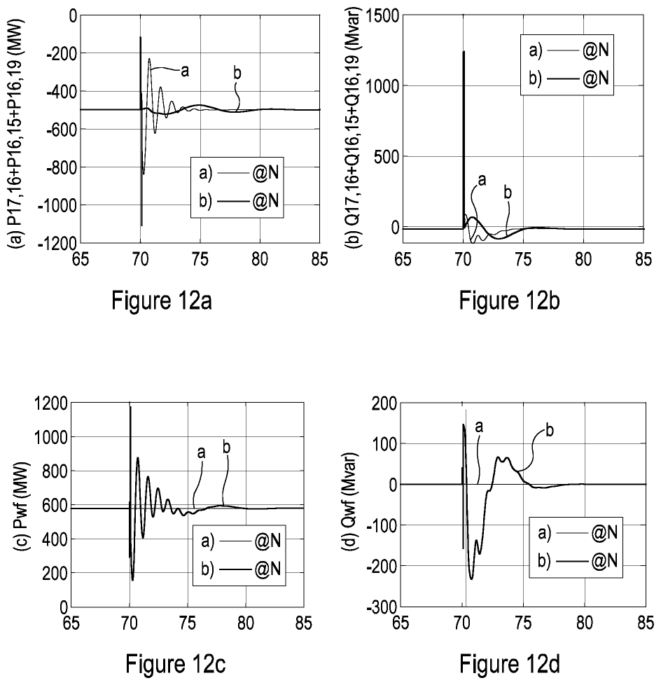

The simulation results of Case 3 are shown in FIGS. 12(a)-(d). FIGS. 12(a)-(b) show that using the proposed Forced Oscillations isolation and suppression strategy, the inter-area oscillations are also well damped. This is because the WF smooths the active and reactive power of transmission lines of T16-24 and T16-21 by generating oscillating power opposite to that of the latter under the proposed control strategy as can be seen from FIG. 12(c)-(d).

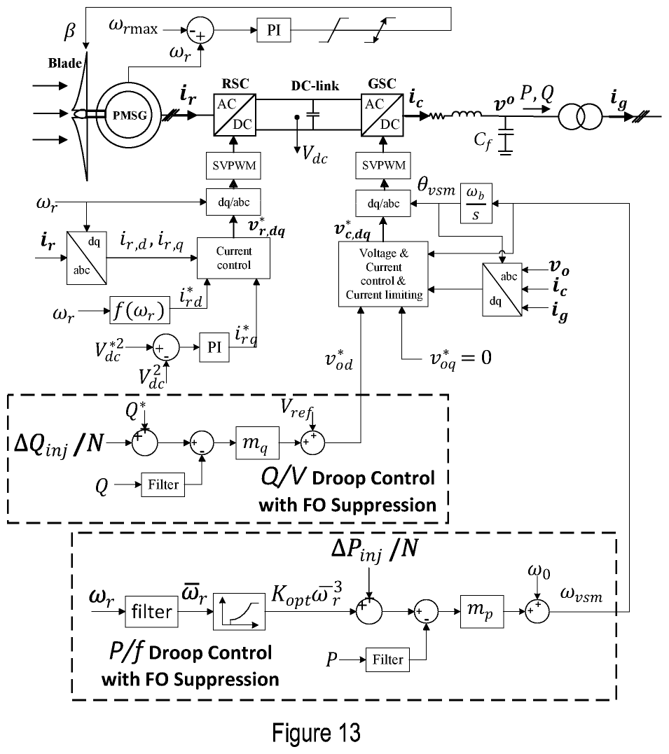

With reference to FIG. 13, there is an example configuration and control structure of a PMSG-based WTS under a grid-forming control principle for implementing the discussed Forced Oscillation isolation and suppression method. The discussed method could also be implemented using other types of wind turbine system such as a doubly fed induction generator (DFIG)-based WTS, other power electronics-interfaced variable speed wind turbine system with induction generator, and synchronous generator (not shown). Utilising a grid-forming control principle is particularly advantageous over a grid-following control principle. Under a grid-forming control principle, the WTS actively regulates system voltage without extra auxiliary loops. Therefore, the grid is more strongly regulated, particularly when more grid-following converters are replaced with grid-forming converters.

The control of the rotor side converter RSC of the system in FIG. 13 is the same as that in FIG. 6. But the grid side control GSC in FIG. 13 is now controlled as a grid-forming converter. Different from the control principle of the GSC in FIG. 6 of using a PLL component to follow the grid voltage frequency and phase, the GSC in FIG. 13 generates the frequency ωᵥₛₘ and phase θᵥₛₘ and amplitude Vₒ⁺ for its output voltage vₒ. Therefore, it actively regulates the grid voltage frequency and amplitude, and can function in the absence of synchronous generators.

P/f and Q/V droop controls, as an example grid-forming control, are used in the GSC in FIG. 13. Other grid-forming control, e.g. virtual oscillator control, dispatchable virtual oscillator control, synchronous machine emulation, etc. could also be used in the GSC. Without the discussed Forced Oscillation isolation and suppression method, in order to be implemented in a WTS the traditional P/f and Q/V droop controls are modified as

$${ω}_{vsm} = {ω}_{0} + {m}_{p} ( {K}_{opt} {ω}_{r}^{3} - \frac{{ω}_{c}}{s + {ω}_{c}} P ) \qquad ( 30 )$$

$${V}_{o}^{*} = {V}_{ref} + {m}_{q} ( {Q}^{*} - \frac{1}{{T}_{Q} s + 1} Q ) \qquad ( 31 )$$

where, ω_{b}, ω₀, and ωᵥₛₘ represent the nominal frequency (rad/s and per unit), and the virtual angular speed, while mₚ and m_{q} are the active and reactive droop gains. ω_{c} and T_{Q} are the cut-off frequency and time constant of the low-pass filters, associated with filtering the active and reactive output power P and Q signals. Kₒₚₜωᵣ³ in (30) is used for maximizing wind power capture for a WTS, where Kₒₚₜ is the optimal coefficient and ωᵣ is the real-time rotational speed of the PMSG.

With the discussed Forced Oscillation isolation and suppression method, the P/f and Q/V droop controls implemented in a WTS are given as

$${ω}_{vsm} = {ω}_{0} + {m}_{p} ( {K}_{opt} {\overline{ω}}_{r}^{3} + \frac{Δ {P}_{inj}}{N} - \frac{{ω}_{c}}{s + {ω}_{c}} P ) \qquad ( 32 )$$

$${V}_{o}^{*} = {V}_{ref} + {m}_{q} ( {Q}^{*} + \frac{Δ {Q}_{inj}}{N} - \frac{1}{{T}_{Q} s + 1} Q ) \qquad ( 33 )$$

where N, ΔPᵢₙⱼ and ΔQᵢₙⱼ, and ω̅ᵣ are the same as that in (28)(29) for a grid-following control based WTS. Again, 1/N can also be replaced by

$$\frac{{ω}_{i}^{2} {S}_{Hi}}{{\sum }_{j = 1}^{N} {ω}_{j}^{2} {S}_{Hj}} .$$

In the GSC in FIG. 13, with the P/f and Q/V droop controls as outer control loops, the cascaded voltage and current controls are used for the inner control loops. Current limiting control for protecting the GSC from overloading is also added in the inner control loops. As in the outer control loop, other functions, e.g. system damping enhancement, secondary and third frequency regulation, voltage secondary regulation, etc. can also be added.

To demonstrate the effectiveness of the proposed Forced Oscillation isolation and suppression method by grid-forming control based WTSs, the 39-bus system in FIG. 7 is simulated, where a WF is located at bus 39 and consists of 500 PMSG-based WTSs under the droop based grid-forming control. During 30˜60 s, an external sinusoidal disturbance 0.04 sin(1.4*2πt) pu is added to the mechanical torque of G1 at Bus 39 to cause Forced Oscillations. The active and reactive power from G1 are chosen to be smoothed by the WF under the disclosed strategy, i.e. −ΔP_{G1} & −ΔQ_{G1} are sent to the WF as ΔPᵢₙⱼ & ΔQᵢₙⱼ in (1)(2), respectively. With additional reference to FIG. 1, G1 belongs to Area 1 while G2-G10 belong to Area 2, and the WF is used to smooth the power outputs of G1 so that the Forced Oscillations originated from G1 will spread by a reduced amount to the rest of the grid, i.e. Area 2.

For the grid-forming control based WTS, the parameters of the wind turbine, PMSG, back-to-back converter, RSC control, the low-pass filters are the same as that for the above grid-following control based WTS. The control parameters of the GSC in the grid-forming control based WTS are:

$${m}_{p} = 0.02 , {m}_{q} = 0.0 \; 001 , {V}_{ref} = 1 pu , {ω}_{c} = 31.4 rad / s , {T}_{Q} = \frac{1}{31.4} s , {ω}_{b} = 314 rad / s , {ω}_{0} = 1 pu ,$$

the proportional-integral gains for the inner voltage and current controllers are 0.52 pu, 1.16 pu, and 0.74 pu, 1.19 pu. The parameters of the LCL filter of the GSC are R_{f}=R_{c}=0.005 pu, L_{f}=L_{c}=0.15 pu, and C_{f}=0.066 pu.

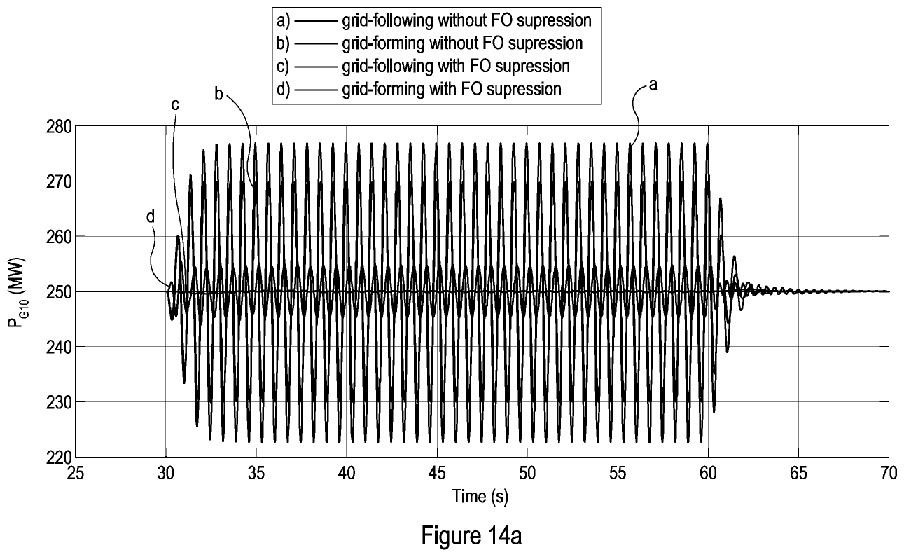

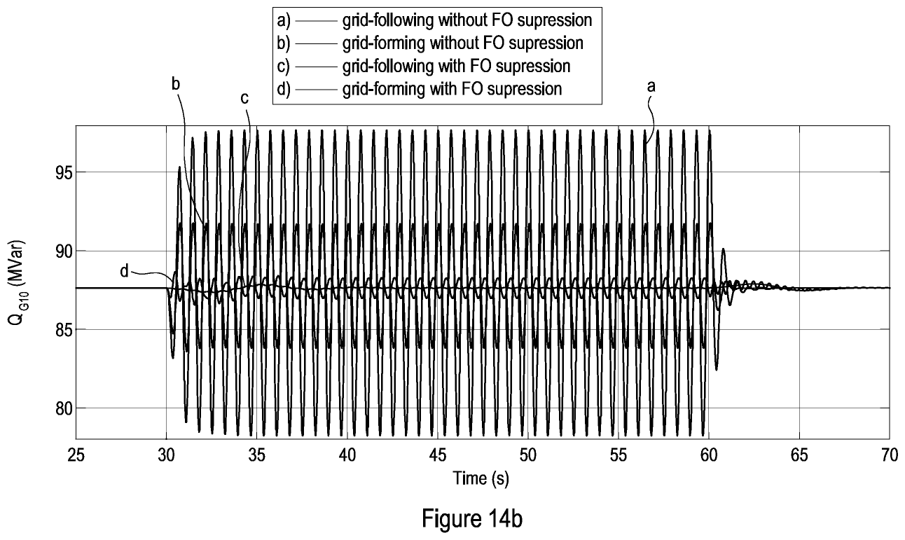

FIGS. 14(a) and 14(b) show a comparison of the simulation results of the active and reactive power outputs respectively of the synchronous generator G10 at bus 30 when the WF is under either the grid-forming or grid-following control, without and with the proposed Forced Oscillation isolation and suppression method (FO suppression). Without the proposed Forced Oscillation isolation and suppression method for the WF, FIG. 14 shows that the active and reactive power oscillations of G10 when the WF is under the grid-forming control are less than that when the WF is under the grid-following control. This exhibits the benefit of suppressing oscillations by just including grid-forming control based WTSs even without extra control strategies in a power system. Using the proposed Forced Oscillation isolation and suppression method for the WF, FIG. 14 shows the oscillations in active and reactive power outputs of G10 are greatly reduced no matter the WF is under grid-following or grid-forming control, while the oscillations are almost eliminated when the WF is under grid-following control. As currently the ratio of the WF capacity over the total capacity of the SGs in the 39-bus system is only 0.1, when the capacity ratio is larger the isolation and suppression effect of the grid-forming control based WF is better (not shown here). This case has demonstrated that grid-forming control based WTSs under the proposed Forced Oscillation isolation and suppression method can isolate and suppress Forced Oscillations well, similar to above grid-following control based WTSs under the proposed Forced Oscillation isolation and suppression method, and the isolation and suppression effect is better when the ratio of the total capacity of the grid-forming control based WTSs over the total capacity of SGs is larger.

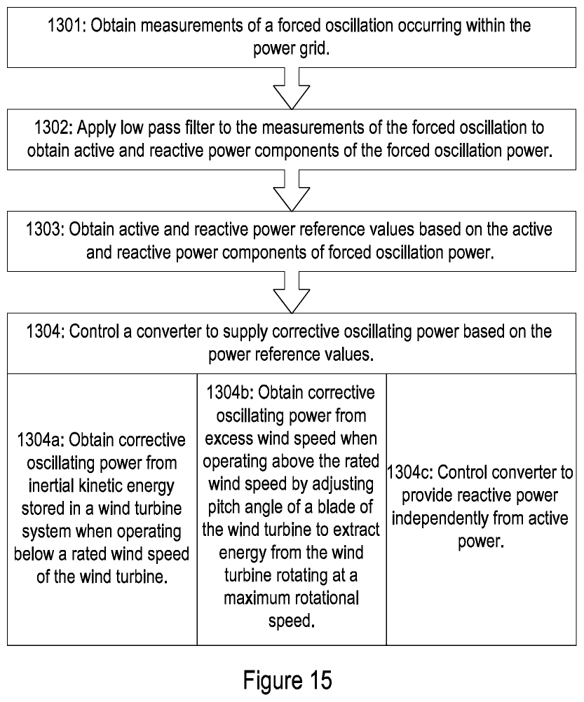

With reference to FIG. 15, there is a flow diagram indicating an example method according to this disclosure. During step 1301, measurements of forced oscillation occurring within the power grid are obtained. During step 1302, a low pass filter is applied to the measurements of forced oscillation to obtain active and reactive power components of the forced oscillating power. During step 1303, active and reactive power reference values are obtained based on the active and reactive power components of forced oscillating power. During step 1304, a converter is controlled to supply corrective oscillating power based on the power reference values thereby neutralising the forced oscillation in the power grid. Active components of the corrective oscillating power can be obtained from inertial kinetic energy stored in a wind turbine system when operating below a rated speed of the wind turbine via step 1304a. If the system is operating above the rated wind speed, then active components of corrective oscillating power is obtained from excess wind speed by adjusting a pitch angle of one or more blades of the wind turbine to extract energy from the wind turbine rotating at maximum rotational speed 1304b. The converter is controlled to provide reactive power independently from active power. Any other method steps set out within this disclosure could be utilised with the method set out in FIG. 15.

This disclosure provides an isolation and suppression strategy for Forced Oscillations using WFs. By controlling WFs to release or absorb active and reactive power opposite to the oscillating power from the selected isolation wall, the Forced Oscillations are isolated within the disturbed area and hence are prevented from propagating to the rest of the system. Meanwhile, the Forced Oscillations excited in the disturbed area (which is bounded by the location of WF installation) are also reduced and suppressed. The effectiveness of the proposed method was supported and explained by theoretical analysis. The 39-bus power system with a PMSG-based WF was simulated using Dymola®. The simulation results considering variable wind speed input and different WF locations with respect to the source of Forced Oscillations demonstrated that the proposed method can well isolate and suppress Forced Oscillations and damp inter-area oscillations, with negligible loss of wind power capture and small increase of the converter capacity.

It will be understood that the invention is not limited to the examples and embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A method of isolating or suppressing forced oscillations in a power grid by utilising a wind turbine system comprising a wind turbine for capturing wind power, a generator driven by the wind turbine, and a power converter configured to control a rotational speed of the generator for controlling a supply of active power to the power grid, wherein the power converter is controlled to supply reactive power to the power grid independently from the supply of active power, the method comprising the steps of:
obtaining measurements of a forced oscillation occurring within the power grid; and
controlling the converter to supply active and reactive corrective oscillating power to the power grid in response to the measured forced oscillation such that the corrective oscillating power suppresses the forced oscillations.

2. The method according to claim 1, wherein the active and reactive corrective oscillating power is provided by controlling the converter to release or absorb active and reactive power opposite to the measured forced oscillation.

3. The method according to claim 1, wherein the active corrective oscillating power is provided by inertial kinetic energy stored in the wind turbine system when below a rated wind speed of the wind turbine and/or by using excess wind energy when above the rated wind speed.

4. The method according to claim 3, wherein a rotational speed of the wind turbine is controlled depending on the wind speed of air flowing through the wind turbine in order to maximise captured wind power for supplying the grid and for supplying active corrective oscillating power.

5. The method according to claim 3, wherein a pitch angle of a blade of the wind turbine is adjusted to extract additional energy from wind flowing through the wind turbine whilst a rotational speed of the wind turbine remains at a maximum rated rotational speed, and wherein the additional energy is utilised for generating active corrective oscillating power.

6. The method according to claim 1, wherein the power grid comprises a first area in which the forced oscillation originates and which is electrically connected to a second area, the method comprising: obtaining the measurements of the forced oscillating power occurring within the first area and injecting the corrective oscillating power into the power grid into the second area.

7. The method according to claim 1, wherein the power grid comprises a first area in which the forced oscillation originates and which is electrically connected to a second area, the method comprising: obtaining the measurements of the forced oscillating power occurring within the first area and injecting the corrective oscillating power between the first ara and the second area.

8. The method according to claim 6, wherein a total oscillating power in the first area is measured at a connection point between the wind turbine system and the first area by using one or more measurement devices including any of a phasor measurement unit, a synchronised measurement unit, and a real-time measurement unit.

9. The method according to claim 6, wherein measurements of forced and/or natural oscillating power are obtained by applying a low pass filter to the measurements of a total oscillating power, wherein the low pass filter is separately applied to active and reactive power components of the measured total power in the first area of the power grid to obtain active and reactive power components of the forced and/or natural oscillating power.

10. The method according to claim 9, wherein the low pass filter has a cut-off frequency that is less than a predetermined minimum frequency of the forced and/or natural oscillations.

11. The method according to claim 9, comprising obtaining active and reactive power reference values based on the corresponding active and reactive power components of forced oscillating power, wherein the converter is controlled based on the corresponding active and reactive power reference values.

12. The method according to claim 11, wherein the active power reference value comprises a sum of i) a maximum wind power reference value, which is based on a measurement of a rotational speed of rotating wind turbine blades, and, ii) measured active forced oscillating power.

13. The method according to claim 12 wherein the measurement of the rotational speed of the rotating wind turbine blades is averaged over a time period.

14. The method according to claim 12, wherein the active and reactive components of the reference power value are based on an available power converter capacity headroom above a current operating point of the power converter in the wind turbine system and a real-time rotational speed of the wind turbine system.

15. The method according to claim 12, wherein the wind turbine system is one of a plurality of communicatively connected wind turbine systems in a wind farm configured to provide load power into the power grid, and wherein the active and reactive power reference values are based on a number of the plurality of wind turbine systems in the wind farm.

16. The method according to claim 1, wherein the power converter comprises a back-to-back converter comprising a rotor-side converter connected directly to the generator and a grid-side inverter connected to the grid, wherein the rotor-side converter and grid-side inverter are connected by a DC link, and wherein the grid-side converter is controlled to providing the corrective oscillating power.

17. The method according to claim 1, wherein the power converter is configured to generate an output frequency, phase, and amplitude of power supplied to the grid in order to function as a grid-forming converter.

18. The wind turbine system for supplying electricity to a power grid whilst suppressing forced oscillating power in the power grid, the wind turbine system comprising a power converter configured to carry out the method according to claim 1.

19. The wind turbine system according to claim 18, wherein the generator is one of a doubly-fed induction generator, a permanent magnet synchronous generator, a power electronics-interfaced variable speed wind turbine system with induction generator, or a synchronous generator.

20. An electricity generation system comprising a first generator in a first area of a power grid, a second generator in a second area of the power grid, and a wind turbine system configured to carry out the method according to claim 1, wherein the wind turbine system is configured to inject the corrective oscillating power into the power grid between the first and second areas thereby suppressing or isolating forced oscillating power generated by the first generator within the first area.

21. A method for measuring forced and/or natural oscillating power in an area of a power grid, the method comprising:
measuring total oscillating power transmitted from the area of the power grid to another area of the power grid at the connection point of a wind turbine system; and
applying a low pass filter to measurements of the total oscillating power to obtain measurements of forced and/or natural oscillating power;
wherein the low pass filter is separately applied to active and reactive power components of the measured total oscillating power to obtain active and reactive components of the forced and/or natural oscillating power; and
wherein the low pass filter has a cut-off frequency that is less than a predefined minimum frequency of forced and/or natural oscillations.
